(19) United States
(12) Patent Application Publication
(10) Pub. No.: US 2026/0243271 A1
(43) Pub. Date: Aug. 20, 2026

(54) CENTRIFUGAL FAN

(71) Applicant: LG ELECTRONICS INC., Seoul (KR)

(72) Inventors: Woojoo CHOI, Seoul (KR); Seungdeok YANG, Seoul (KR); Bonchang HWANG, Seoul (KR); Seokho CHOI, Seoul (KR)

(73) Assignee: LG ELECTRONICS INC., Seoul (KR)

(21) Appl. No.: 19/159,880

(22) PCT Filed: Feb. 7, 2024
(86) PCT No.: PCT/KR2024/001800

§ 371 Date: Aug. 26, 2025

(30) Foreign Application Priority Data
Feb. 27, 2023 (KR) 10-2023-0026132

(51) Int. Cl. F04D 29/28; F04D 17/08

(52) U.S. Cl. CPC F04D 29/281; F04D 17/08

(57) ABSTRACT

The present disclosure relates to a centrifugal fan. The centrifugal fan of the present disclosure comprises: a hub connected to a motor; a shroud having a suction port into which air flows; and blades arranged between the hub and the shroud, where-in the blade includes: a mast which has a leading edge, and into which air flows; and a sail body which extends from the mast to a trailing edge, and which is formed to protrude or recede in the rotation direction, and the mast can include: a front mast having a thickness that increases while extending from the leading edge; and a rear mast which is connected to the sail body, and which has a thickness that decreases while extending from the front mast.

### TECHNICAL FIELD

The present disclosure relates to a centrifugal fan, and more particularly, to a centrifugal fan having a sail-shaped airfoil.

### BACKGROUND ART

A centrifugal fan is a fan that discharges the air, which is flowed in axially through a shroud, in a circumferential direction through between blades. Factors affecting the performance of a centrifugal fan include the shape, angle, and number of blade. Recently, active research has been conducted on the effects of blade shape on the efficiency, physical characteristics, productivity, and maintainability of centrifugal fans.

Korean Patent No. 2104513 discloses a “centrifugal fan for blowing air” comprising: a base; a shroud; and a plurality of blades spaced apart from each other along the circumference of the base at between the base and the shroud, wherein the plurality of blades are formed into a convex plate shape.

The above-mentioned mentioned conventional centrifugal fan for blowing air has a problem in that the blades are manufactured in a convex plate shape having the same cross-section in the axial direction, resulting in low blowing efficiency.

Korean Patent No. 2122260 discloses a “centrifugal fan” comprising: a main plate; a shroud; an airfoil-shaped blade arranged between the main plate and the shroud, wherein the blades have the same airfoil-shaped cross-section in the axial direction, and the chord lines connecting a leading edge and a trailing edge are all located on the same plane.

In the above-mentioned conventional “centrifugal fan”, the blades are formed into an airfoil shape, which increases the blowing efficiency compared to the plate-shaped conventional blades, but there is still a problem that the airflow efficiency is low because the blades have the same airfoil-shaped cross-section in the axial direction and the chord lines are all located on the same plane.

Furthermore, the airfoil-shaped blades do not have a hollow interior, which causes the centrifugal fan to be heavy.

Korean U.S. Pat. No. 1,645,178 discloses a “centrifugal fan” comprising: a main plate; a shroud; and a plurality of blades arranged along a circumferential direction at between the main plate and the shroud, wherein the blades are formed by mutual bonding between a pair of members made of curved metal plates.

The above-mentioned conventional “centrifugal fan” has the problem of increased manufacturing costs and a complex manufacturing process, as it requires manufacturing a pair of metal plates corresponding to the positive and negative pressure surfaces respectively and then welded together.

Even if the blades are formed as one body through injection molding, there is a problem that the cross-section of the blade is formed in a 3D shape with different axial shapes, so that it is impossible to slim down the inside of the blade. In this case, there is a problem that the weight of the centrifugal fan increases.

### PRIOR ART DOCUMENTS

Korean Patent Publication No. 10-2104513 B1 (Announcement Date: Apr. 27, 2020)

Korean Patent Publication No. 10-2122260 B1 (Announcement Date: Jun. 12, 2020)

Korean Patent Publication No. 10-1645178 B1 (Announcement Date: Aug. 3, 2016)

### DISCLOSURE

### Technical Problem

An object of the present disclosure may be to provide a centrifugal fan with improved blowing performance.

Another object of the present disclosure may be to provide a centrifugal fan with reduced flow separation.

Another object of the present disclosure may be to provide a centrifugal fan with improved physical characteristics.

Another object of the present disclosure may be to provide a lightweight centrifugal fan.

Another object of the present disclosure may be to provide a centrifugal fan with reduced blade volume.

Another object of the present disclosure may be to provide a centrifugal fan with reduced blade cross-sectional area.

Another object of the present disclosure may be to provide a centrifugal fan with blade cross-sections that vary into the axial direction.

Another object of the present disclosure may be to provide a centrifugal fan with improved rigidity.

Another object of the present disclosure may be to provide a centrifugal fan with reduced manufacturing costs.

Another object of the present disclosure may be to provide a centrifugal fan with a simplified manufacturing process.

The objects of the present disclosure are not limited to the objects mentioned above, and other objects not mentioned will be clearly understood by those skilled in the art from the description below.

### Technical Solution

According to one aspect of the present disclosure for achieving the above-described object, a centrifugal fan includes a hub connected to a motor; a shroud having a suction port into which air flows; and a blade arranged between the hub and the shroud, in which the blade includes: a mast which has a leading edge, and into which air flows; and a sail body which extends from the mast to a trailing edge, and is convexly or concavely formed in a rotation direction, in which the mast includes: a front mast having a thickness that increases while extending from the leading edge; and a rear mast which is connected to the sail body, and has a thickness that decreases while extending from the front mast, so that the cross-sectional area of the blade can be reduced compared to a conventional airfoil-shaped blade.

The blade includes: one surface which has one convex surface of the mast and one convex surface of the sail body; and an other surface which has an other convex surface of the mast and an other concave surface of the sail body, so that the shape of the blade can be formed in a streamlined shape.

A cross-section of the blade includes: one side arranged on one surface of the blade; and an other side arranged on the other side of the blade, in which the one side is formed in a shape of an upper camber of an airfoil.

The other surface of the mast is formed convexly in a direction opposite to a direction in which the one surface of the mast is formed convexly, and the other surface of the sail body is formed concavely in a direction corresponding to a direction in which the one surface of the sail body is formed convexly, so that the other surface of the blade may be recessed.

The sail body is formed in a streamlined shape, and at least a portion of the sail body gradually decreases in thickness as it progresses toward the trailing edge.

The sail body is formed of a plate having a filled internal space, so that the manufacturing process can be simplified.

The blade includes: a first contact surface which is connected to the shroud, and has a first point located on the trailing edge; and a second contact surface which is connected to the hub, and has a second point located on the trailing edge, in which a distance between a rotation axis and the first point is longer than a distance between the rotation axis and the second point, thereby allowing for better airflow.

The trailing edge of the blade includes a third point located between the first point and the second point, and a distance between a rotation axis and the third point is shorter than a distance between the rotation axis and the second point, thereby allowing for better airflow.

At least one of the first contact surface and the second contact surface is formed in an airfoil shape, so that the area in which the blade comes in contact with the hub and the shroud can be increased.

In the blade, a direction of a chord line, which is a straight line connecting the leading edge and the trailing edge, varies as it progresses from the shroud to the hub, so that the shape of the blade can be formed in a three-dimensional shape.

The direction of the chord line is a direction from the leading edge toward the trailing edge, and in at least a portion of the blade, the direction of the chord line varies into a rotation direction as it progresses from the shroud to the hub.

The blade includes: a first blade which is connected to the shroud, and extends in a direction of rotation axis; and a second blade which extends from the first blade in the direction of rotation axis and is connected to the hub.

In the first blade, the direction of the chord line varies into a rotation direction of rotation axis as it gets farther away from the shroud, and in the second blade, the direction of the chord line varies into an opposite direction to the rotation direction of rotation axis as it progresses from the first blade to the hub.

A length of the cord line of the first blade becomes shorter as it gets farther away from the shroud, and a length of the cord line of the second blade becomes longer as it progresses closer to the hub.

A curvature of cross-sectional shape of the blade becomes smaller as it progresses from the shroud to the hub.

Specific details of other embodiments are included in the detailed description and drawings.

### Advantageous Effects

According to at least one embodiment of the present disclosure, the blade includes a mast which extends from a leading edge, while having a thickness s that increases and then decreases, and a sail body which extends from the mast and is convexly formed, thereby reducing the cross-sectional area compared to a conventional airfoil-shaped blade.

According to at least one embodiment of the present disclosure, the weight of the centrifugal fan can be reduced, as the cross-sectional area of the blade, which includes the mast and the streamlined sail body, is reduced.

According to at least one embodiment of the present disclosure, one side of the cross-section of the blade arranged on one surface of the blade is formed in the upper camber shape of airfoil, thereby minimizing a decrease in the performance of the centrifugal fan.

According to at least one embodiment of the present disclosure, the performance of the centrifugal fan can be improved by forming one surface of the blade in the shape of airfoil.

According to at least one embodiment of the present disclosure, the other surface of the mast is formed convexly in the direction opposite to the direction in which the other surface of the mast is convexly formed, so that the airflow flowing into the leading edge is guided to the other surface of the concave sail body, thereby improving the flow separation phenomenon.

According to at least one embodiment of the present disclosure, the other surface of the mast is formed convexly, and the other surface of the sail body extends concavely from the other surface of the mast, thereby improving the flow separation phenomenon and enhancing the performance of the centrifugal fan.

According to at least one embodiment of the present disclosure, the sail body is formed streamlined, and at least a portion of the sail body is gradually decreased in thickness as it progresses toward the trailing edge, thereby improving the flow separation phenomenon and enhancing the performance of the centrifugal fan. Furthermore, the cross-sectional area is reduced to reduce the volume of the blades, thereby reducing the weight of the centrifugal fan.

According to at least one embodiment of the present disclosure, the inner side of the blade is filled, thereby simplifying the manufacturing process and reducing manufacturing costs.

According to at least one embodiment of the present disclosure, the third point is closer to the rotation axis than the first and second points, thereby improving flow efficiency and enhancing the performance of the centrifugal fan.

According to at least one embodiment of the present disclosure, at least one of the first and second contact surfaces of the blade is formed in an airfoil shape, thereby increasing the area of contact between the blade and the hub and/or shroud, thereby enhancing the rigidity of the centrifugal fan.

According to at least one embodiment of the present disclosure, the direction of the chord line, which is a straight line connecting the leading and trailing edges, changes as it progresses from the shroud to the hub, thereby improving flow efficiency and enhancing the performance of the centrifugal fan.

The effects of the present invention are not limited to the effects mentioned above, and other effects not mentioned will be clearly understood by those skilled in the art from the description of the claims.

### DESCRIPTION OF DRAWINGS

FIG. 1 is a perspective view of a centrifugal fan according to an embodiment of the present disclosure.

FIG. 2 is a side view of a centrifugal fan according to an embodiment of the present disclosure.

FIG. 3 is a plan view of a centrifugal fan according to an embodiment of the present disclosure.

FIG. 4 is a perspective view of a blade according to an embodiment of the present disclosure.

FIG. 5 is a perspective view of a blade according to an embodiment and another embodiment of the present disclosure.

FIG. 6 is a cross-sectional view of a conventional blade and a cross-sectional view of a blade according to an embodiment of the present disclosure.

FIG. 7 is a photograph showing experimental results showing the flow rate of air flowing along a conventional blade and experimental results showing the flow rate of air flowing along a blade according to an embodiment of the present disclosure.

FIG. 8 is a cross-sectional view of a blade according to an embodiment of the present disclosure.

FIG. 9 is a cross-sectional view of a blade according to an embodiment of the present disclosure.

FIG. 10 is a drawing illustrating a rotating centrifugal fan according to an embodiment of the present disclosure.

FIG. 11 is an elevation view of a blade according to an embodiment of the present disclosure.

FIG. 12 is a cross-sectional view of a blade according to another embodiment of the present disclosure.

FIG. 13 is a graph showing experimental results showing the efficiency depending on air volume according to a conventional blade and a blade according to an embodiment of the present disclosure.

### MODE FOR INVENTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

It will be understood that when an element is referred to as being “connected with” another element, there may be intervening elements present. In contrast, it will be understood that when an element is referred to as being “directly connected with” another element, there are no intervening elements present.

A singular representation may include a plural representation unless context clearly indicates otherwise.

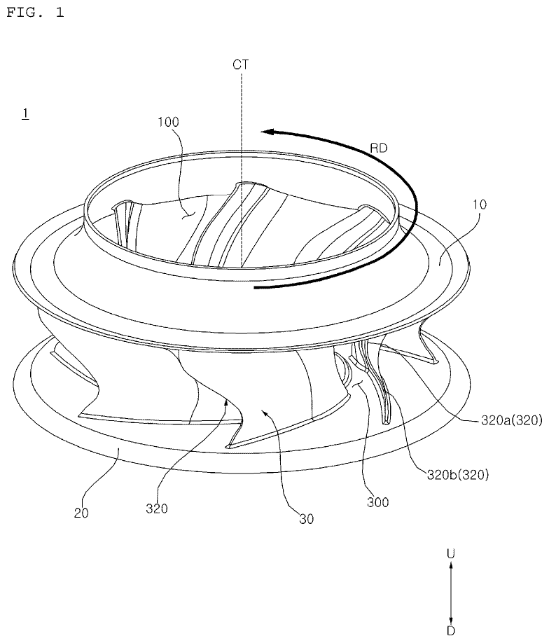

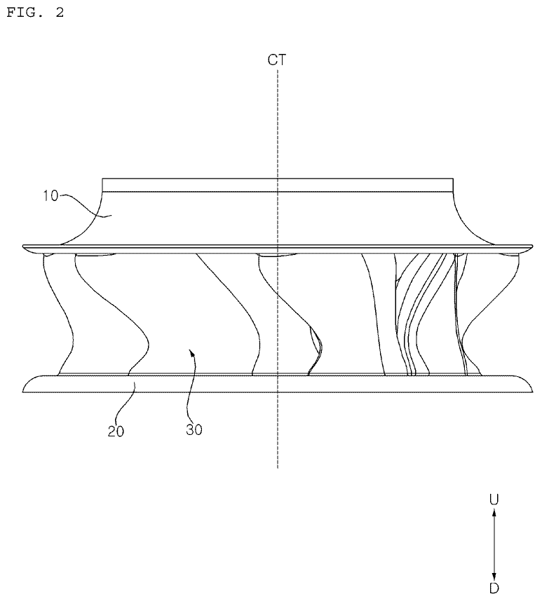

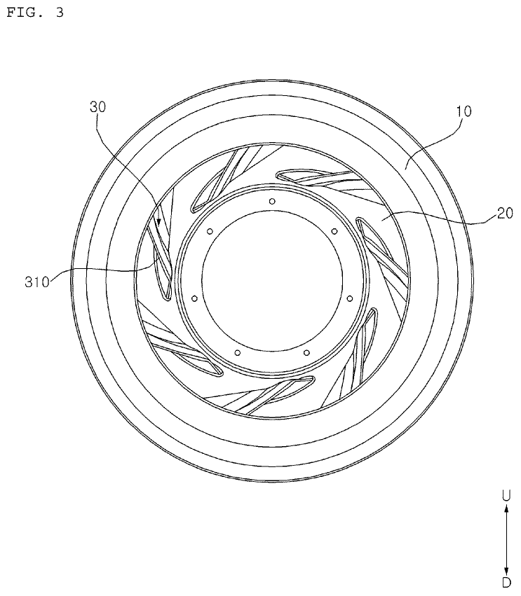

A centrifugal fan 1 will be described with reference to FIGS. 1 to 3.

The centrifugal fan 1 includes a hub 20, a shroud 10, and a blade 30.

The hub 20 may be connected to a motor. The shaft of the motor may be connected to the hub 20. The hub 20 may transmit the rotational power of the motor to the shroud 10 and the blades 30. When the motor rotates, the hub 20 may rotate together with the shaft of the motor. As the hub 20 rotates, the blade 30 and the shroud 10 may rotate. For example, the hub 20 may be a circular plate to which the shaft of the motor is coupled and which is arranged below the shroud 10 and the blades 30.

The shroud 10 has a suction port 100 through which air flows in. The shroud 10 may be a circular plate. The diameter of the shroud 10 may correspond to the diameter of the hub 20. For example, the hub 20 and the shroud 10 may be formed as circular plates having the same diameter.

The suction port 100 may be formed at the central portion of the shroud 10. The shroud 10 may protrude toward the central portion. The suction port 100 may be opened at the central portion of the shroud 10. The suction port 100 may be a circular opening. For example, a circular open suction port 100 may be formed at the central portion of the shroud 10. The diameter of the suction port 100 may be smaller than the diameter of the shroud 10. The perimeter of the suction port 100 may be the inner perimeter of the shroud 10. The perimeter of the suction port 100 may be spaced inward from the outer perimeter of the shroud 10. For example, the shroud 10 may be a circular plate that protrudes upward as it approaches a circular suction port 100 formed at the central portion.

The shroud 10 may be spaced apart from the hub 20. Blades 30 are arranged between the hub 20 and the shroud 10. There may be a plurality of blades 30. The plurality of blades 30 may be spaced apart from each other in a circumferential direction based on a central axis. For example, the plurality of blades 30 may be spaced apart from each other radially based on a rotation axis CT of the centrifugal fan 1.

A blowing passage 300 may be formed between the plurality of blades 30 spaced apart from each other. Accordingly, the air flowed in through the suction port 100 may be discharged through the blowing passage 300 formed between the plurality of blades 30.

The blade 30 is formed with a leading edge 310. Air may be flowed into the leading edge 310 of the blade 30. The leading edge 310 of the blade 30 may be located on the inside of the centrifugal fan 1. The leading edges 310 of the plurality of blades may be located on a virtual first circumference spaced inwardly from the outer perimeter of the hub 20.

The blade 30 is formed with a trailing edge 320. Air may be discharged to the trailing edge 320 of the blade 30. The trailing edge 320 of the blade 30 may be located on the outside of the centrifugal fan 1. The trailing edges 320 of the plurality of blades 30 may be located on a virtual second circumference spaced inwardly from the outer perimeter of the hub 20. The diameter of the first circumference where the trailing edges 320 of the plurality of blades 30 are arranged may be larger than the diameter of the second circumference where the leading edges 310 of the plurality of blades 30 are arranged.

The blade 30 may extend from the leading edge 310 to the trailing edge 320. The blade 30 may extend radially and circumferentially. The blade 30 may extend radially and simultaneously extend in a direction opposite to the rotation direction RD. For example, the blades 30 may extend radially and extend simultaneously in a clockwise direction. The trailing edge 320 may be spaced radially from the leading edge 310. The trailing edges 320 may be spaced circumferentially from the leading edge 310. The trailing edge 320 may be spaced in a direction opposite to the rotation direction RD as it progresses radially from the leading edge 310. For example, the trailing edge 320 may be spaced clockwise as it progresses radially from the leading edge 310.

The leading edge 310 and the trailing edge 320 may extend long in the direction of the rotation axis CT. The leading edge 310 may be a curved shape extending in the direction of the rotation axis CT. The trailing edge 320 may be a curved shape extending in the direction of the rotation axis CT. The leading edge 310 and the trailing edge 320 may be formed in different curved shapes. The curvature of the trailing edge 320 may be greater than the curvature of the leading edge 310. For example, the curvature of the longitudinal section of the blade 30 may increase as it progresses from the leading edge 310 to the trailing edge 320.

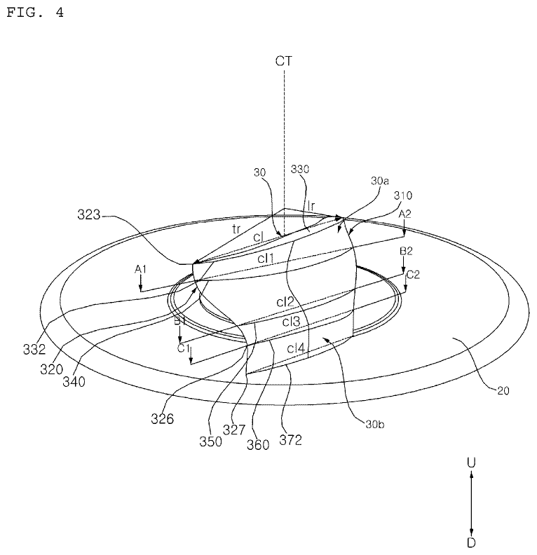

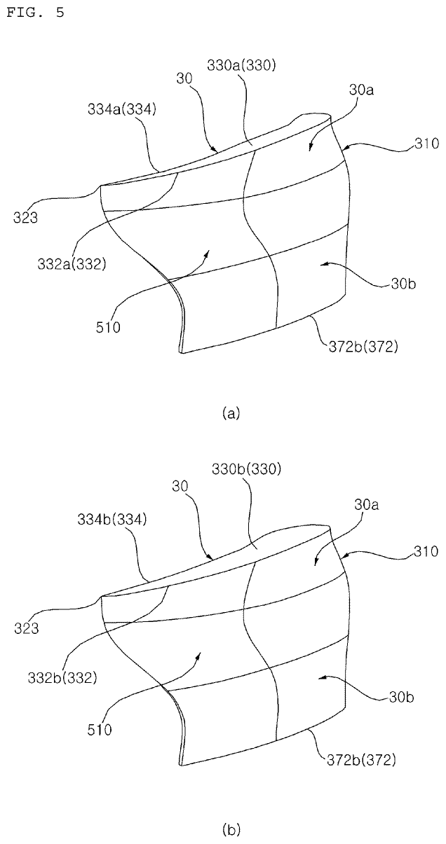

Referring to FIGS. 4 and 5, the blade 30 will be described.

The blade 30 may include a first contact surface 330 connected to the shroud 10. The first contact surface 330 may be the upper surface of the blade 30. For example, the first contact surface 330 may be the top surface of the blade 30. The shape of the first contact surface 330 may correspond to the shape of the cross-section of the blade 30.

The first contact surface 330 may include a first positive pressure end 512. The first positive pressure end 512 may be a corner where the first contact surface 330 and a positive pressure surface 510 meet. The shape of the first positive pressure end 512 may be the shape of an upper camber of airfoil. The first contact surface 330 may include a first negative pressure end 522. The first negative pressure end 522 may be a corner where the first contact surface and a negative pressure end 520 meet. A first point 323 may be a vertex where the first positive pressure end 512, the first negative pressure end 522, and the trailing edge 320 meet. The first contact surface 330 may be an area surrounded by the first positive pressure end 512 and the first negative pressure end 522.

The shape of the first contact surface 330 may be formed as an airfoil shape. The shape of the first negative pressure end 522 may be the shape of a lower camber of airfoil. For example, the shape of the first contact surface 330 may be formed as an airfoil shape, and the first negative pressure end 522 may be the shape of lower camber. Through this, the contact area between the blade 30 and the shroud 10 may be increased. Accordingly, the bonding force between the blade 30 and the shroud 10 may be enhanced.

In addition, the rigidity of the centrifugal fan may be improved.

The blade 30 may include a second contact surface 370 connected to the hub 20. The second contact surface 370 may be the lower surface of the blade 30. For example, the second contact surface 370 may be the bottom surface of the blade 30. The shape of the second contact surface 370 may correspond to the shape of the cross-section of the blade 30.

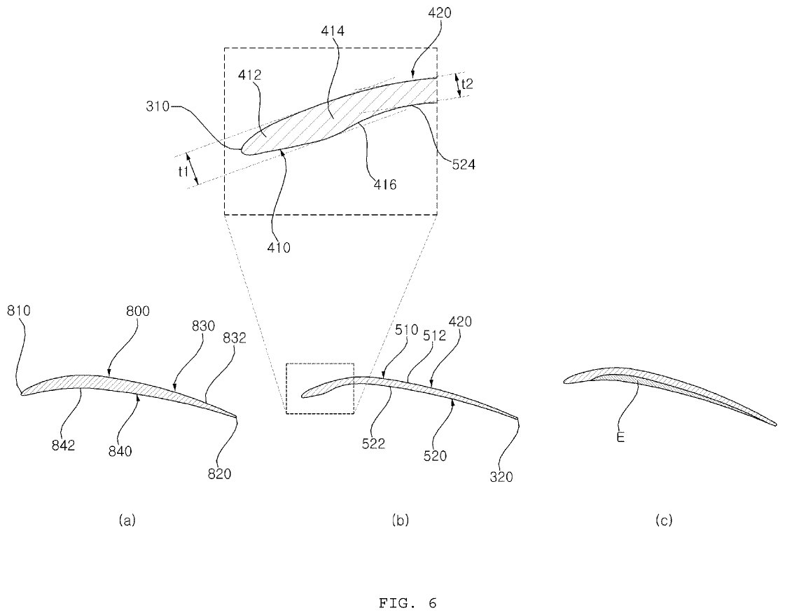

The second contact surface 370 may include a second positive pressure end 512. The second positive pressure end 512 may be a corner where the second contact surface 370 and the positive pressure surface 510 meet. The shape of the second positive pressure end 512 may be the shape of the upper camber of airfoil. The second contact surface 370 may include a second negative pressure end (not shown). The second negative pressure end 522 may be a corner where the second contact surface and the negative pressure surface 520 (see FIG. 6) meet. A second point 327 may be a vertex where the second positive pressure end 512, the second negative pressure end 522, and the trailing edge 320 meet. The second contact surface 370 may be a cross-section surrounded by the second positive pressure end 512 and the second negative pressure end 522.

The shape of the second contact surface 370 may be formed in the shape of an airfoil. The shape of the second negative pressure end may be the shape of the lower camber of airfoil. For example, the shape of the second contact surface 370 may be formed in the shape of airfoil, and the second negative pressure end may be the shape of lower camber. This may increase the contact area between the blade and the hub. Accordingly, the bonding force between the blade and the hub may be enhanced.

In addition, the rigidity of the centrifugal fan may be improved.

A chord line cl may be a virtual straight line connecting the leading edge 310 and the trailing edge 320. The direction of the chord line cl may correspond to the extension direction of the blade 30. The direction of the chord line cl may be from the leading edge 310 towards the trailing edge 320. The chord line cl may extend circumferentially as it progresses in the radial direction. The chord line cl may extend in the rotation direction RD or in the direction opposite to the rotation direction RD as it progresses in the radial direction. For example, the chord line cl may extend clockwise as it progresses in the radial direction.

The leading edge 310 may be spaced apart from the rotation axis CT by a certain distance lr. The trailing edge 320 may be spaced apart from the rotation axis CT by a certain distance tr. The distance tr by which the trailing edge 320 is spaced apart from the rotation axis CT may be greater than the distance lr by which the leading edge 310 is spaced apart from the rotation axis CT. The distance lr by which the leading edge 310 is spaced apart from the rotation axis CT may vary along the direction of the rotation axis CT. The distance tr by which the trailing edge 320 is spaced from the rotation axis CT may vary along the direction of the rotation axis CT.

The trailing edge 320 may extend in the direction of the rotation axis CT. The trailing edge 320 may be curved with an inflection point. The inflection point may be located at the central portion of the trailing edge 320.

The trailing edge 320 may include a first trailing edge 320a connected to the shroud 10. The first trailing edge 320a may bend in a direction opposite to the rotation direction RD. The first trailing edge 320a may be a portion of the trailing edge 320. The first trailing edge 320a may extend in the direction of the rotation axis CT. For example, the first trailing edge 320a may extend in the direction of the rotation axis CT to form the upper portion of the trailing edge 320, and may be bent downward in a clockwise direction. The first trailing edge 320a may be bent outward. For example, the first trailing edge 320a may be bent downward in a clockwise direction and bent outward simultaneously.

The trailing edge 320 may include a second trailing edge 320b connected to the hub 20. The second trailing edge 320b may be bent in the rotation direction RD. The second trailing edge 320b may be a portion of the trailing edge 320. The second trailing edge 320b may extend in the direction of the rotation axis CT. For example, the second trailing edge 320b may extend in the direction of the rotation axis CT to form the lower portion of the trailing edge 320, and may be bent upward in a counterclockwise direction. The second trailing edge 320b may be bent inward. For example, the second trailing edge 320b may be bent upward in a counterclockwise direction and bent inward simultaneously.

The first trailing edge 320a and the second trailing edge 320b may be connected. The first trailing edge 320a and the second trailing edge 320b may be directly connected. The first trailing edge 320a may form a portion of the trailing edge 320, and the second trailing edge 320b may form the remaining portion of the trailing edge 320. For example, the trailing edge 320 may include a first trailing edge 320a forming an upper portion, and a second trailing edge 320b extending downward from the lower end of the first trailing edge 320a to form a lower portion. The inflection point may be located between the first trailing edge 320a and the second trailing edge 320b. The inflection point may be a point where the bending direction of the trailing edge changes. For example, the inflection point may be a point of change in the bending direction located between the first trailing edge 320a bent downward in the opposite direction of the rotation direction and the second trailing edge 320b bent upward in the rotation direction.

The first contact surface 330 may have a first point 323. The first point 323 may be the rear end of the first contact surface 330. The first point 323 may be one end of the trailing edge 320. For example, the first point 323 may be a vertex where the first contact surface 330 and the trailing edge 320 meet.

The second contact surface 370 may include a second point 327. The second point 327 may be the rear end of the second contact surface 370. The second point 327 may be the other end of the trailing edge 320. For example, the second point 327 may be a vertex where the second contact surface 370 and the trailing edge 320 meet.

The distance tr between the first point 323 and the rotation axis CT may be longer than the distance tr4 between the second point 327 and the rotation axis CT.

The trailing edge 320 may include a third point 326 located between the first point 323 and the second point 327. The third point 326 may be located on the cross-section of the blade 30. For example, the third point 326 may be located on a third cross-section 360 described below. The third point 326 may be the rear end of the third cross-section 360. The third point 326 may be a point where the third cross-section 360 and the trailing edge 320 meet. The third point 326 and the inflection point may be a different point.

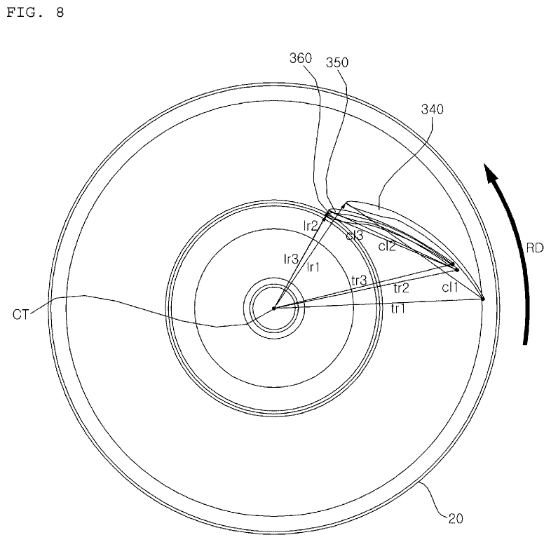

The distance tr3 (see FIG. 8) between the third point 326 and the rotation axis CT may be shorter than the distance tr2 between the second point 327 and the rotation axis CT. The distance from the rotation axis CT may become shorter as it progresses from the first point 323 to the third point 326. The distance from the rotation axis CT may become longer as it progresses from the third point 326 to the second point 327. For example, the distance between the trailing edge 320 and the rotation axis CT may become shorter as it progresses from the first point 323 to the third point 326, and may become longer as it progresses from the third point 326 to the second point 327.

Referring to FIG. 6, the blade 30 will be described.

FIG. 6A is a cross-sectional view of an airfoil shape of a conventional blade.

The conventional blade 800 may have a cross-section of an airfoil shape. One surface 830 of the conventional blade 800 may be formed convexly in one direction. The other surface 840 of the conventional blade 800 may be formed concavely in one direction. For example, the conventional blade 800 may include a positive pressure surface 830 and a negative pressure surface 840 opposite to the positive pressure surface 830. The positive pressure surface 830 may be formed convexly in one direction, and the negative pressure surface 840 may be formed concavely in the one direction.

The conventional blade 800 may include one end 832 forming one side of the cross-section. The one end 832 may be arranged on the one surface 830 of the conventional blade 800. The one end 832 may be formed convexly in one direction. The one end 832 may be formed in the shape of an upper camber of airfoil. For example, the conventional blade 800 may include a positive pressure end 832 which forms one side of a cross-section and is arranged on the positive pressure surface 830. The positive pressure end 832 may be formed in the shape of an upper camber of airfoil.

The conventional blade 800 may include the other end 842 forming the other side of a cross-section. The other end 842 may be arranged on the other surface 840 of the conventional blade 800. The other end 842 may be formed to be concave in one direction. The other end 842 may be formed in the shape of a lower camber of airfoil. For example, the conventional blade 800 may include a negative pressure end 842 which forms the other side of a cross-section and is arranged on a negative pressure surface 840. The above-described negative pressure end 842 may be formed in the shape of a lower camber of airfoil.

The conventional blade 800 may include a leading edge 810 through which air flows in. The leading edge 810 may connect a positive pressure surface 830 and a negative pressure surface 840. The conventional blade 800 may include a trailing edge 820 through which air is discharged. The trailing edge 820 may connect the positive pressure surface 830 and the negative pressure surface 840. For example, the conventional blade 800 may extend from the leading edge 810 to the trailing edge 820. The leading edge 810 may connect the positive pressure surface 830 and the negative pressure surface 840 at the front side, and the trailing edge 820 may connect the positive pressure surface 830 and the negative pressure surface 840 at the rear side.

FIG. 6B is a cross-sectional view of a blade according to an embodiment of the present disclosure.

The blade 30 includes a mast 410 and a sail body 420.

Air is flowed in toward the mast 410. The mast 410 may be formed in a streamlined shape. The leading edge 310 may be formed on the mast 410. The trailing edge 320 may be formed on the sail body 420. The thickness of the mast 410 may increase and then decrease as it gets farther away from the leading edge 310. The thickness of the mast 410 may increase and then decrease as it progresses from the leading edge to the trailing edge 320. The thickness t1 of the middle portion of the mast 410 may be greater than the thickness t2 of the rear end portion. For example, a streamlined mast 410 may have a thickness that increases from both end portions to the middle.

One surface of the mast 410 may be formed to be convex in one direction. The other surface of the mast 410 may be formed to be convex in the other direction. The other direction may be the opposite direction to the one direction. One surface of the mast 410 may be a portion of the positive pressure surface 510. The other surface of the mast 410 may be a portion of the negative pressure surface 520. The curvature of the other surface of the mast 410 may be greater than the curvature of the one surface of the mast 410. The radius of curvature of the other surface of the mast 410 may be smaller than the radius of curvature of the one surface of the mast 410. For example, one surface of the mast 410 forming a portion of the positive pressure surface 510 is formed to be convex in one direction, the other surface of the mast 410 forming a portion of the negative pressure surface 520 is formed to be convex in the opposite direction to the one direction, and the curvature of the other surface of the mast 410 may be greater than the curvature of the one surface of the mast 410.

The mast 410 includes a front mast 410 having a thickness that increases. The front mast 410 may extend from the leading edge 310. The front mast 410 may have a thickness that increases as it gets farther away from the leading edge 310. The front mast 410 may have a thickness that increases as it approaches the trailing edge 320. The front mast 410 may have a thickness that increases as it progresses rearward. The front mast 410 may have a thickness that increases as it approaches the front mast 410.

The mast 410 includes a rear mast 410 having a thickness that decreases. The rear mast 410 extends from the front mast 410. The rear mast 410 may be directly connected to the front mast 410. The rear mast 410 may have a thickness that decreases as it gets farther away from the leading edge 310. The rear mast 410 may have a thickness that decreases as it approaches the trailing edge 320. The rear mast 410 is connected to the sail body 420. The rear mast 410 may have a thickness that decreases as it approaches the sail body 420. The thickness of the front side of the rear mast 410 may correspond to the thickness of the rear side of the rear mast 410. The thickness of the rear side of the rear mast 410 may be less than the thickness of the front side. The thickness of the rear side of the rear mast 410 may be less than the thickness of the rear side of the front mast 410.

The sail body 420 may be formed in a streamlined shape. The sail body 420 may be formed in a curved shape. The sail body 420 extends from the mast 410 toward the trailing edge. The sail body 420 may be directly connected to the mast 410. The thickness of the sail body 420 may gradually decrease as at least a portion of the thickness of the sail body 420 progresses toward the trailing edge. For example, the sail body 420 may be directly connected to the rear mast 410, and the thickness of the sail body 420 may gradually decrease as at least a portion extends toward the trailing edge 320.

The sail body 420 may be formed as an internally filled plate. The interior of the sail body 420 may not have a hollow space. Accordingly, there is no need to form a hollow space inside the blade to reduce the weight of the three-dimensionally shaped blade, thereby reducing manufacturing costs and simplifying the manufacturing process.

Furthermore, the productivity of the centrifugal fan may be improved.

The sail body 420 may be formed convexly in one direction. The sail body 420 may be formed convexly or concavely in the rotation direction. For example, the sail body 420 may be formed convexly in the rotation direction.

The blade 30 may include the positive pressure surface 510 and the negative pressure surface 520. The positive pressure surface 510 may be one surface of the blade. The negative pressure surface 520 may be the other surface of the blade.

The sail body 420 may be formed convexly on one surface. One surface of the sail body 420 may be included in one surface 510 of the blade 30. One surface of the sail body 420 may be included in the positive pressure surface 510.

The other surface of the sail body 420 may be concave. The other surface of the sail body 420 may be concave in a direction corresponding to the direction in which one surface of the sail body 420 is convex. The curvature of the other surface of the sail body 420 may be greater than the curvature of one surface of the sail body 420. The radius of curvature of the other surface of the sail body 420 may be smaller than the radius of curvature of one surface of the sail body 420. The other surface of the sail body 420 may be included in the other surface of the blade 30. The other surface of the sail body 420 may be included in the negative pressure surface 520.

The blade 30 may include one surface that includes one surface of the mast 410 and one surface of the sail body 420. One surface of the blade 30 may be a positive pressure surface. One surface of the mast 410 may be convex. One surface of the sail body 420 may be convex.

The blade 30 may include the other surface having the other surface of the mast 410 and the other surface of the sail body 420. The other surface 520 of the blade 30 may be a negative pressure surface 520. The other surface of the mast 410 may be convex. The other surface of the sail body 420 may be concave.

The cross-section of the blade 30 may include one end 512 forming one side. One end 512 of the cross-section of the blade 30 may be located on one surface 510 of the blade 30. One end 512 of the cross-section of the blade 30 may be formed in an airfoil shape. For example, one end 512 of the cross-section of the blade 30 may be the positive pressure end 512 arranged on the positive pressure surface 510, and the positive pressure end 512 may be formed in the upper camber shape of airfoil.

The cross-section of the blade 30 may include the other end 522 forming the other side. The other end 522 of the cross-section of the blade 30 may be arranged on the other surface 520 of the blade 30. The other end 522 of the cross-section of the blade 30 may include the other end of the convexly formed mast 410 and the other end of the concavely formed sail body 420.

FIG. 6C is a drawing comparing the cross-section of a conventional blade with the cross-section of a blade according to an embodiment of the present disclosure.

The positive pressure end 832 of the cross-section of the conventional blade 800 and the positive pressure end 512 of the blade 30 according to an embodiment of the present disclosure may be formed in the same shape. That is, both the positive pressure end 832 of the cross-section of the conventional blade 800 and the positive pressure end 512 of the blade 30 according to an embodiment of the present disclosure may be formed in the upper camber shape of an airfoil.

The negative pressure end 842 of the cross-section of the conventional blade 800 and the negative pressure end 522 of the blade 30 according to an embodiment of the present disclosure may be formed in different shapes. The negative pressure end 842 of the cross-section of the conventional blade 800 may be formed in the shape of a lower camber of an airfoil. The negative pressure end 522 of the blade 30 according to an embodiment of the present disclosure may be located within the cross-section of the conventional blade 800. The length of the negative pressure end 522 of the blade 30 according to an embodiment of the present disclosure may be longer than the length of the negative pressure end 842 of the cross-section of the conventional blade 800.

The shape of the other end 512 of the front mast 410 according to an embodiment of the present disclosure may correspond to a portion of the shape of the lower camber of airfoil. That is, the other end 512 of the front mast 410 may overlap with a portion of the negative pressure end 842 of the conventional blade 800.

The other end 416 of the rear mast 410 according to an embodiment of the present disclosure may be located within the cross-section of the conventional blade 800. Accordingly, the other surface of the rear mast 410 may be referred to as a first recess 416. That is, the negative pressure surface 520 of the rear mast 410 may be recessed compared to the negative pressure surface 840 of the conventional blade 800. Accordingly, the cross-sectional area and volume of the blade may be reduced, thereby reducing the weight of the centrifugal fan.

The other end 522 of the sail body 420 according to an embodiment of the present disclosure may be located within the cross-section of the conventional blade 800. Accordingly, the other surface 520 of the sail body 420 may be referred to as a first body recess 520. That is, the negative pressure surface 520 of the sail body 420 may be recessed compared to the negative pressure surface 840 of the conventional blade 800. Accordingly, the cross-sectional area and volume of the blade may be reduced, thereby reducing the weight of the centrifugal fan.

Due to the first recess 416 and the first body recess 514, the blade 30 according to an embodiment of the present disclosure may have a cross-sectional area reduced by the indicated portion E compared to the conventional blade 800, thereby reducing the overall volume.

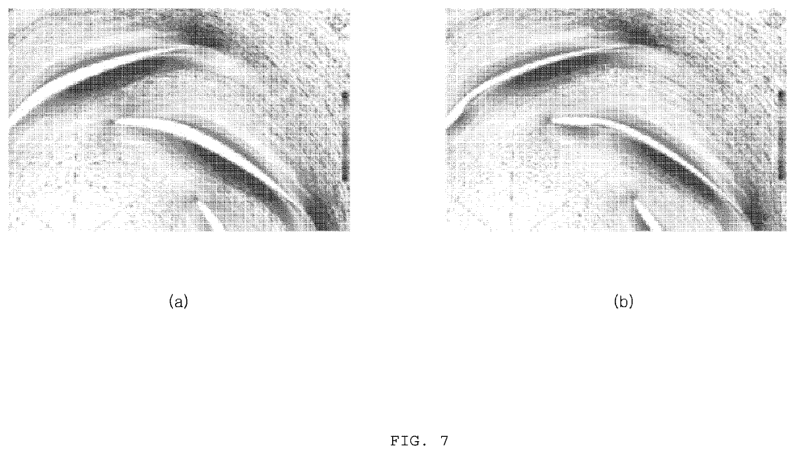

The blade 30 will be described with reference to FIG. 7.

FIG. 7A is an experimental result photograph showing the flow rate during rotation of a conventional blade.

FIG. 7B is an experimental result photograph showing the flow rate during rotation of a blade according to an embodiment of the present disclosure.

According to the experimental results, it may be checked that the conventional blade 800 and the blade 30 according to an embodiment of the present disclosure have some differences in cross-section and shape, but the formed air flow is similarly formed. That is, even if the negative pressure surface 520 of the blade 30 according to an embodiment of the present disclosure is partially recessed, it may be checked that the flow separation phenomenon is controlled, and a flow very similar to the flow of a centrifugal fan equipped with a conventional airfoil-shaped blade 800 is formed.

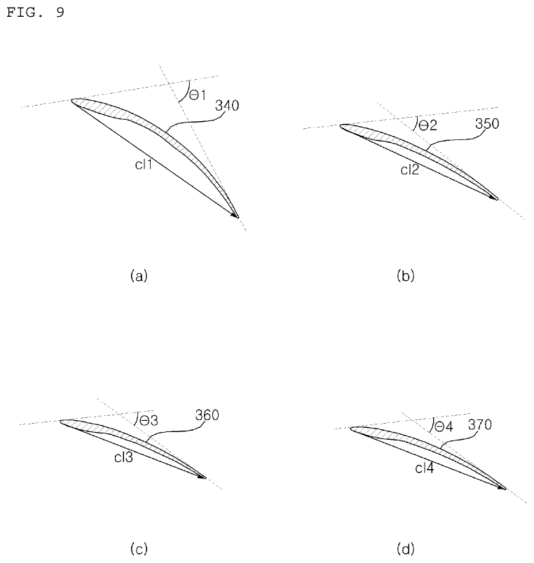

Referring to FIGS. 8 and 9, the blade 30 will be described.

The blade 30 may have a cross-sectional shape that changes along the rotation axis CT. A first cross-section 340 is a cross-sectional view taken along line A1-A2 of FIG. 4. A second cross-section 350 is a cross-sectional view taken along line B1-B2 of FIG. 4. A third cross-section 360 is a cross-sectional view taken along line C1-C2 of FIG. 4. The first cross-section 340 may be located closer to the shroud 10 than the second cross-section 350 and the third cross-section 360. For example, the first cross-section 340 may be located higher than the second cross-section 350 and the third cross-section 360. The second cross-section 350 may be located between the first cross-section 340 and the third cross-section 360. The second cross-section 350 may be located closer to the shroud 10 than the third cross-section 360. The second cross-section 350 may be located closer to the hub 20 than the first cross-section 340. The third cross-section 360 may be located closer to the hub 20 than the first cross-section 340 and the second cross-section 350. The second contact surface 370 may connect the blade 30 and the hub 20. For example, the third cross-section 360 may be arranged above the second contact surface 370, the second cross-section 350 may be arranged above the third cross-section 360, and the first cross-section 340 may be arranged above the second cross-section 350.

The area of the first cross-section 340 may be greater than the areas of the second cross-section 350 and the third cross-section 360. The area of the second cross-section 350 may be greater than the area of the third cross-section 360. The area of the second contact surface 370 may be greater than the area of the third cross-section 360. For example, the area of the third cross-section 360 may be smaller than the areas of the first cross-section 340, the second cross-section 350, and the second contact surface 370.

The distance tr between the rotation axis CT and the trailing edge 320 may vary along the direction of the rotation axis CT. The distance tr1 between the trailing edge of the first cross-section 340 and the rotation axis CT may be longer than the distance tr2 between the trailing edge of the second cross-section 350 and the rotation axis CT. The distance tr2 between the trailing edge of the second cross-section 350 and the rotation axis CT may be longer than the distance tr3 between the trailing edge of the third cross-section 360 and the rotation axis CT. The distance tr between the rotation axis CT and the trailing edge 320 may become shorter as it progresses from the first contact surface 330 to the third cross-section 360.

The distance lr between the rotation axis CT and the leading edge 310 may vary along the direction of the rotation axis CT. The distance lr1 between the leading edge of the first cross-section 340 and the rotation axis CT may be longer than the distance lr2 between the leading edge of the second cross-section 350 and the rotation axis CT. The distance lr2 between the leading edge of the second cross-section 350 and the rotation axis CT may be longer than the distance lr3 between the leading edge of the third cross-section 360 and the rotation axis CT. The distance lr between the rotation axis CT and the leading edge 310 may become shorter as it progresses from the first contact surface 330 to the third cross-section 360. The distance lr between the rotation axis CT and the leading edge 310 may become shorter as it progresses from the first contact surface 330 to the second contact surface 370.

The mast 410 may have a distance lr from the rotation axis CT that becomes shorter as it progresses from the shroud 10 to the hub 20. The mast 410 may move forward in the rotation direction as it progresses from the shroud 10 to the hub 20. The leading edge 310 may move forward in the rotation direction RD as it progresses from the shroud 10 to the hub 20. For example, the mast 410 may move forward in the rotation direction RD as it progresses from the shroud 10 to the hub 20, and the distance lr from the rotation axis CT may become shorter.

The size of the mast 410 may vary along the direction of the rotation axis CT. The size of the mast 410 may decrease as it progresses from the shroud 10 to the hub 20. The extended length of the mast 410 may vary along the rotation axis CT. For example, the extended length of the mast 410 may become shorter and the size of the mast 410 may become smaller, as it progresses from the shroud 10 to the hub 20.

The direction of the chord line cl may vary along the rotation axis CT. The direction of the chord line cl may vary as it progresses from the shroud 10 to the hub 20. The direction of the chord line cl may vary into the circumferential direction as it progresses from the shroud 10 to the hub 20. The direction of the chord line cl may vary into the rotation direction as it progresses from the shroud 10 to the hub 20.

In at least a portion of the blade 30, the direction of the cord line cl may vary into the rotation direction RD as it progresses from the shroud 10 to the hub 20. For example, the blade 30 includes a first blade 30a between the first contact surface 330 and the third cross-section 360, and the direction of the chord line cl of the first blade 30a may vary into the rotation direction RD as it gets farther away from the shroud 10. For example, the direction of the chord line cl may gradually vary into the rotation direction RD along the direction of the first chord line cl1, the direction of the second chord line cl2, and the direction of the third chord line cl3, as it progresses from the shroud 10 to the hub 20.

The direction of the chord line cl of a portion of the blade 30 may vary into the rotation direction RD as it gets farther away from the shroud 10, and the direction of the chord line cl of the remaining portion of the blade 30 may vary into the opposite direction of the rotation direction RD as it approaches the hub 20. The blade 30 may include a first blade 30a between the first contact surface 330 and the third cross-section 360, and a third blade 30 between the third cross-section 360 and the second contact surface 370. The first blade 30a may be connected to the shroud 10. The second blade 30b may be connected to the hub 20. For example, the direction of the chord line cl of the first blade 30a may vary into the rotation direction RD as it gets farther away from the shroud 10, and the direction of the chord line cl of the second blade 30b may vary into the direction opposite to the rotation direction RD as it approaches the hub 20. For example, the direction of the chord line cl may vary into the rotation direction RD along the direction of the first chord line cl1, the direction of the second chord line cl2, and the direction of the third chord line cl3 as it progresses from the shroud 10 to the hub 20, and may vary into the opposite direction of the rotation direction RD from the direction of the third chord line cl3 toward the direction of the fourth chord line cl4.

At least a portion of the blade 30 may have a length of chord line cl that becomes shorter as it gets farther away from the shroud 10. For example, the first blade 30a may have a length of the chord line cl that becomes shorter as it gets farther away from the shroud 10. For example, the length of the first chord line cl1 may be longer than the length of the second chord line cl2, and the length of the second chord line cl2 may be longer than the length of the third chord line cl3.

A portion of the blade 30 may have a length of chord line cl that becomes shorter as it gets farther away from the shroud 10, and the remaining portion of the blade 30 may have a length of chord line cl that becomes longer as it gets closer to the hub 20. For example, the first blade 30a may have a length of chord line cl that becomes shorter as it gets farther away from the shroud 10, and the second blade may have a length of chord line cl that becomes longer as it gets closer to the hub 20. For example, the length of the first chord line cl1 may be longer than the length of the second chord line cl2, the length of the second chord line cl2 may be longer than the length of the third chord line cl3, and the length of the third chord line cl3 may be shorter than the length of the fourth chord line cl4.

The curvature of the blade 30 may change along the direction of the rotation axis CT. The curvature of the blade 30 may decrease as it progresses from the shroud 10 to the hub 20. The radius of curvature of the blade 30 may increase as it progresses from the shroud 10 to the hub 20. For example, the curvature of the first cross-section 340 may be greater than the curvature of the second cross-section 350, the curvature of the second cross-section 350 may be greater than the curvature of the third cross-section 360, and the curvature of the third cross-section 360 may be greater than the curvature of the second contact surface 370.

Based on one surface of the cross-section of the blade 30, the angle ceta formed by a tangent line to the leading edge 310 and a tangent line to the trailing edge 320 may decrease as it progresses from the shroud 10 to the hub 20. Based on the first cross-section 340, the angle formed by the tangent line to the leading edge 310 and the tangent line to the trailing edge 320 is referred to as a first angle ceta 1. Based on the second cross-section 350, the angle formed by the tangent line to the leading edge 310 and the tangent line to the trailing edge 320 is referred to as a second angle ceta 2. Based on the third cross-section 360, the angle formed by the tangent line to the leading edge 310 and the tangent line to the trailing edge 320 is referred to as a third angle ceta 3. Based on the second contact surface 370, the angle formed by the tangent line to the leading edge 310 and the tangent line to the trailing edge 320 is referred to as a fourth angle ceta 4. The first angle ceta 1 may be greater than the second angle ceta 2. The second angle ceta 2 may be greater than the third angle ceta 3. The third angle ceta 3 may be greater than the fourth angle ceta 4.

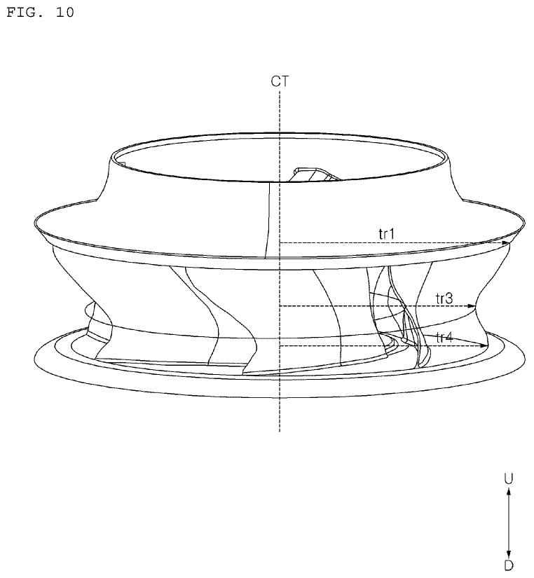

Referring to FIG. 10, the blade 30 will be described.

FIG. 10 is a drawing showing the rotational trace of the rear end of the blade when the centrifugal fan rotates.

The distance tr at which the trailing edge 320 is spaced from the rotation axis CT may vary along the direction of the rotation axis CT. The distance tr1 between the upper end 323 of the trailing edge 320 and the rotation axis CT may be longer than the distance tr4 between the lower end 327 of the trailing edge 320 and the rotation axis CT. The distance tr4 between the lower end 327 of the trailing edge 320 and the rotation axis CT may be longer than the distance between a point in the central portion of the trailing edge 320 and the rotation axis CT. For example, the distance tr1 between a first point 323 and the rotation axis CT may be longer than the distance tr4 between a second point 327 and the rotation axis CT. Furthermore, the distance tr3 between the trailing edge 320 of the third cross-section 360 and the rotation axis CT may be shorter than the distance tr4 between the second point 327 and the rotation axis CT.

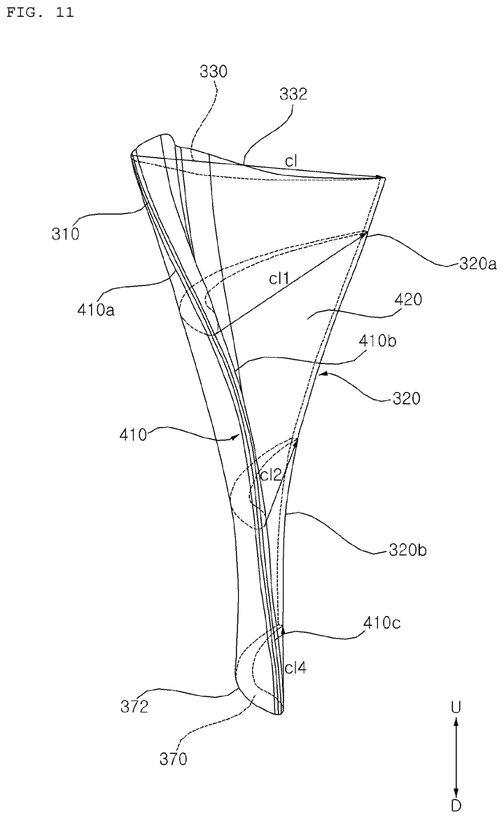

Referring to FIG. 11, the blade 30 will be described.

The mast 410 may be extended long in the direction of the rotation axis CT. The mast 410 may be curved with an inflection point. The distance between the mast 410 and the rotation axis CT may vary along the direction of the rotation axis CT.

The mast 410 may include a first mast 410a connected to the shroud 10. The first mast 410a may be a portion of the mast 410. For example, the first mast 410a may be connected to the shroud 10 and may form an upper portion of the mast 410. The first mast 410a may be bent outward. The first mast 410a may be bent in a radial direction. The first mast 410a may be formed to be convex in a radial direction. For example, the first mast 410a may be bent downwardly convex in a radial direction.

The mast 410 may include a second mast 410b extending from the first mast 410a. The second mast 410b may be a portion of the mast 410. The first mast 410a may be a portion of the mast 410, and the second mast 410b may form the remaining portion of the mast 410. In this case, the second mast 410b may be connected to the hub 20, and may form the lower portion of the mast 410. The second mast 410b may be bent inward. The second mast 410b may be bent in a direction opposite to the radial direction. The second mast 410b may be bent convexly in a direction opposite to the radial direction. For example, the second mast 410b may be bent convexly upward in a direction opposite to the radial direction.

The inflection point of the mast 410 may be located between the first mast 410a and the second mast 410b. Based on the inflection point, a portion of the mast 410 and the remaining portion may change their bending direction.

The mast 410 may include a third mast 410c located between the first mast 410a and the second mast 410b. The third mast 410c may be connected to the hub 20. The second mast 410b may be located between the first mast 410a and the third mast 410c. For example, the third mast 410c may be connected to the hub 20, and form the lower portion of the mast 410. The first mast 410a may be bent outward. The first mast 410a may be bent in a radial direction. The first mast 410a may be convex in a radial direction. For example, the first mast 410a may be bent downwardly convex in a radial direction.

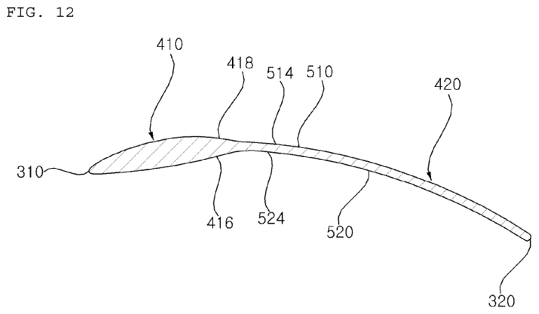

Referring to FIG. 12, the blade 30 will be described.

One surface of the blade 30 may be recessed. For example, the positive pressure surface of the blade 30 may be recessed. The first recess 416 and the first body recess 514 may be formed on the other surface of the blade 30, and the second recess 418 and the second body recess 524 may be formed on one surface of the blade 30. The positive pressure surface of the rear mast 410 may be recessed. This may be referred to as a second recess 418.

The positive pressure surface of the sail body 420 may be recessed compared to the positive pressure surface 830 of the conventional blade 800. This may be referred to as a second body recess 524. The sail body 420 may extend rearward from the mast 410 with a constant thickness. One surface 510 of the sail body 420 may be formed convexly in one direction, and the other surface 520 of the sail body 420 may be formed concavely in one direction. The curvature of the one side 510 of the sail body 420 may correspond to the curvature of the other surface 520.

One surface 510 of the blade 30 may be formed by one surface of the mast 410 formed convexly and one surface of the sail body 420 formed convexly. At this time, the curvature of one surface of the mast 410 may be greater than the curvature of one surface of the sail body 420. The radius of curvature of one surface of the mast 410 may be smaller than the radius of curvature of one surface of the sail body 420. The second recess 418 may connect one surface of the sail body 420 and one surface of the front mast 410. The second recess 418 may form one surface of the rear mast 410.

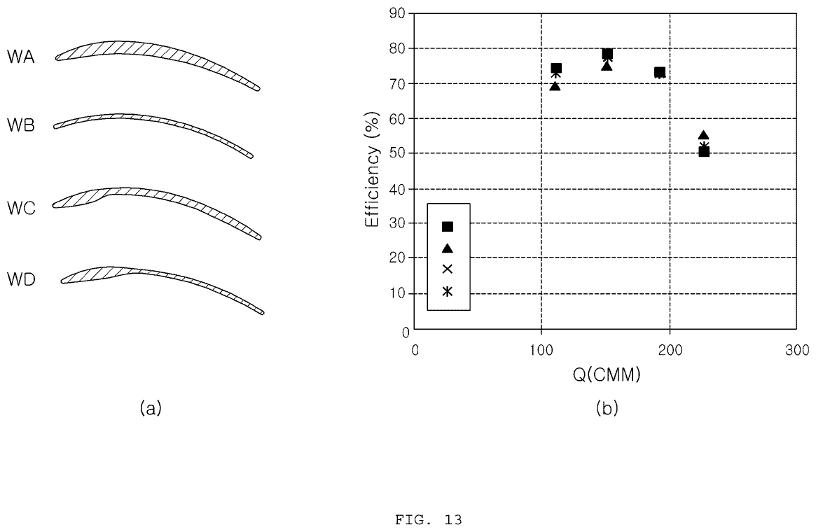

Referring to FIG. 13, the centrifugal fan 1 will be described.

FIG. 13 is a graph showing the results of an efficiency-air volume comparison analysis of blades having different shapes. Specifically, the graph shows the results of an efficiency-air volume comparison analysis according to an airfoil-shaped blade WA, a flat-plate-shaped blade WB, a blade WC according to an embodiment of the present disclosure, and a blade WD according to another embodiment of the present disclosure.

The air volume increases as it progresses to the right, and the efficiency increases as it progresses to the upper side. At a relatively low air volume of 100 CMM, the airfoil-shaped blade WA exhibits the highest efficiency, and then the blade WC according to an embodiment of the present disclosure and the blade WD according to another embodiment exhibit similar efficiencies. The flat-plate-shaped blade WB exhibits the lowest efficiency.

At an air volume of approximately 150 CMM, the efficiency gap between the experimental groups is small, but the flat-plate-shaped blade WB exhibits the lowest efficiency compared to the blades of other shapes WA, WC, and WD.

At an air volume of approximately 190 CMM, the efficiency gap between the experimental groups is virtually nonexistent.

At an air volume of approximately 220 CMM, the flat-plate-shaped blade WB exhibits the highest efficiency, and then the blade WD according to another embodiment of the present disclosure, the blade WC according to an embodiment, and the airfoil-shaped blade WA exhibit high efficiency in that order.

In light of the above experimental results, the airfoil-shaped blade WA generally exhibits stable, high efficiency, but the blades WC, WD according to the embodiments of the present disclosure are, in efficiency, only marginally different from or nearly equivalent to the airfoil shaped blade WA. In addition, the blades WC, WD according to the embodiments of the present disclosure show that a maximum efficiency is increased by approximately 2% compared to the flat-plate-shaped blade WB.

Referring to FIGS. 1 to 13, a centrifugal fan according to an aspect of the present disclosure includes: a hub connected to a motor; a shroud having a suction port into which air flows; and a blade arranged between the hub and the shroud, in which the blade includes: a mast which has a leading edge, and into which air flows; and a sail body which extends from the mast to a trailing edge, and is convexly or concavely formed in a rotation direction, in which the mast includes: a front mast having a thickness that increases while extending from the leading edge; and a rear mast which is connected to the sail body, and has a thickness that decreases while extending from the front mast.

According to another aspect of the present disclosure, the blade includes: one surface which has one convex surface of the mast and one convex surface of the sail body; and an other surface which has an other convex surface of the mast and an other concave surface of the sail body, in which a cross-section of the blade includes: one side arranged on one surface of the blade; and an other side arranged on the other side of the blade, in which the one side is formed in a shape of an upper camber of an airfoil.

According to another aspect of the present disclosure, the other surface of the mast is formed convexly in a direction opposite to a direction in which the one surface of the mast is formed convexly, and the other surface of the sail body is formed concavely in a direction corresponding to a direction in which the one surface of the sail body is formed convexly.

According to another aspect of the present disclosure, the other side of the cross-section of the blade may be located on the other surface of the blade.

According to another aspect of the present disclosure, the sail body is formed in a streamlined shape, and at least a portion of the sail body gradually decreases in thickness as it progresses toward the trailing edge.

According to another aspect of the present disclosure, in the mast, a distance of the mast spaced from a rotation axis becomes shorter as it progresses from the shroud to the hub.

According to another aspect of the present disclosure, the mast moves forward in a rotation direction as it progresses from the shroud to the hub.

According to another aspect of the present disclosure, the mast has a curved shape that extends in a direction of rotation axis, and has an inflection point.

According to another aspect of the present disclosure, the mast includes: a first mast which is connected to the shroud, and bent in a radial direction; and a second mast which connects the first mast and the hub, and is bent in a direction opposite to the radial direction, in which the inflection point is located between the first mast and the second mast.

According to another aspect of the present disclosure, the sail body is formed of a plate having a filled internal space.

According to another aspect of the present disclosure, the blade includes: a first contact surface which is connected to the shroud, and has a first point located on the trailing edge; and a second contact surface which is connected to the hub, and has a second point located on the trailing edge, in which a distance between a rotation axis and the first point is longer than a distance between the rotation axis and the second point.

According to another aspect of the present disclosure, the trailing edge of the blade includes a third point located between the first point and the second point, in which a distance between a rotation axis and the third point is shorter than a distance between the rotation axis and the second point.

According to another aspect of the present disclosure, at least one of the first contact surface and the second contact surface is formed in an airfoil shape.

According to another aspect of the present disclosure, the trailing edge of the blade extends in a direction of rotation axis, and has an inflection point.

According to another aspect of the present disclosure, the trailing edge of the blade includes: a first trailing edge which is connected to the shroud, and bent in a direction opposite to a rotation direction of rotation axis; and a second trailing edge which connects the first trailing edge and the hub, and is bent in the rotation direction of rotation axis, in which the inflection point is located between the first trailing edge and the second trailing edge.

According to another aspect of the present disclosure, in the blade, a direction of a chord line, which is a straight line connecting the leading edge and the trailing edge, varies as it progresses from the shroud to the hub.

According to another aspect of the present disclosure, direction of the chord line is a direction from the leading edge toward the trailing edge, and in at least a portion of the blade, the direction of the chord line varies into a rotation direction as it progresses from the shroud to the hub.

According to another aspect of the present disclosure, the blade includes: a first blade which is connected to the shroud, and extends in a direction of rotation axis; and a second blade which extends from the first blade in the direction of rotation axis and is connected to the hub, in which in the first blade, the direction of the chord line varies into a rotation direction of rotation axis as it gets farther away from the shroud, and in the second blade, the direction of the chord line varies into an opposite direction to the rotation direction of rotation axis as it progresses from the first blade to the hub.

According to another aspect of the present disclosure, a length of the cord line of the first blade becomes shorter as it gets farther away from the shroud, and a length of the cord line of the second blade becomes longer as it progresses closer to the hub.

According to another aspect of the present disclosure, a curvature of cross-sectional shape of the blade becomes smaller as it progresses from the shroud to the hub.

According to another aspect of the present disclosure, the cross-sectional area of the mast becomes smaller as it progresses from the shroud to the hub.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A centrifugal fan comprising:
a hub connected to a motor;
a shroud having a suction port into which air flows; and
a blade arranged between the hub and the shroud,
wherein the blade comprises:
a mast which has a leading edge, and into which air flows; and
a sail body which extends from the mast to a trailing edge, and is convexly or concavely formed in a rotation direction,
wherein the mast comprises:
a front mast having a thickness that increases while extending from the leading edge; and
a rear mast which is connected to the sail body, and has a thickness that decreases while extending from the front mast.

2. The centrifugal fan of claim 1, wherein the blade comprises:
one surface which has one convex surface of the mast and one convex surface of the sail body; and
an other surface which has an other convex surface of the mast and an other concave surface of the sail body,
wherein a cross-section of the blade comprises:
one side arranged on one surface of the blade; and
an other side arranged on the other side of the blade,
wherein the one side is formed in a shape of an upper camber of an airfoil.

3. The centrifugal fan of claim 2, wherein the other surface of the mast is formed convexly in a direction opposite to a direction in which the one surface of the mast is formed convexly, and
the other surface of the sail body is formed concavely in a direction corresponding to a direction in which the one surface of the sail body is formed convexly.

4. The centrifugal fan of claim 1, wherein the sail body is formed in a streamlined shape, and at least a portion of the sail body gradually decreases in thickness as it progresses toward the trailing edge.

5. The centrifugal fan of claim 1, wherein in the mast, a distance spaced from a rotation axis becomes shorter as it progresses from the shroud to the hub.

6. The centrifugal fan of claim 5, wherein the mast moves forward in a rotation direction as it progresses from the shroud to the hub.

7. The centrifugal fan of claim 5, wherein the mast has a curved shape that extends in a direction of rotation axis, and has an inflection point.

8. The centrifugal fan of claim 7, wherein the mast comprises:
a first mast which is connected to the shroud, and bent in a radial direction; and
a second mast which connects the first mast and the hub, and is bent in a direction opposite to the radial direction,
wherein the inflection point is located between the first mast and the second mast.

9. The centrifugal fan of claim 1, wherein the sail body is formed of a plate having a filled internal space.

10. The centrifugal fan of claim 1, wherein the blade comprises:
a first contact surface which is connected to the shroud, and has a first point located on the trailing edge; and
a second contact surface which is connected to the hub, and has a second point located on the trailing edge,
wherein a distance between a rotation axis and the first point is longer than a distance between the rotation axis and the second point.

11. The centrifugal fan of claim 10, wherein the trailing edge of the blade comprises a third point located between the first point and the second point,
wherein a distance between a rotation axis and the third point is shorter than a distance between the rotation axis and the second point.

12. The centrifugal fan of claim 10, wherein at least one of the first contact surface and the second contact surface is formed in an airfoil shape.

13. The centrifugal fan of claim 1, wherein the trailing edge of the blade extends in a direction of rotation axis, and has an inflection point.

14. The centrifugal fan of claim 13, wherein the trailing edge of the blade comprises:
a first trailing edge which is connected to the shroud, and bent in a direction opposite to a rotation direction of rotation axis; and
a second trailing edge which connects the first trailing edge and the hub, and is bent in the rotation direction of rotation axis,
wherein the inflection point is located between the first trailing edge and the second trailing edge.

15. The centrifugal fan of claim 1, wherein in the blade, a direction of a chord line, which is a straight line connecting the leading edge and the trailing edge, varies as it progresses from the shroud to the hub.

16. The centrifugal fan of claim 15, wherein the direction of the chord line is a direction from the leading edge toward the trailing edge, and
in at least a portion of the blade, the direction of the chord line varies into a rotation direction as it progresses from the shroud to the hub.

17. The centrifugal fan of claim 16, wherein the blade comprises:
a first blade which is connected to the shroud, and extends in a direction of rotation axis; and
a second blade which extends from the first blade in the direction of rotation axis and is connected to the hub,
wherein in the first blade, the direction of the chord line varies into a rotation direction of rotation axis as it gets farther away from the shroud, and
in the second blade, the direction of the chord line varies into an opposite direction to the rotation direction of rotation axis as it progresses from the first blade to the hub.

18. The centrifugal fan of claim 17, wherein a length of the cord line of the first blade becomes shorter as it gets farther away from the shroud, and
a length of the cord line of the second blade becomes longer as it progresses closer to the hub.

19. The centrifugal fan of claim 1, wherein a curvature of cross-sectional shape of the blade becomes smaller as it progresses from the shroud to the hub.
